(19) United States
(12) Patent Application Publication
(10) Pub. No.: US 2025/0130146 A1
(43) Pub. Date: Apr. 24, 2025

(54) Methods and Systems for Extracting Analytes From a Sample

(71) Applicant: DH Technologies Development Pte. Ltd., Singapore (SG)

(72) Inventors: Thomas COVEY, Concord (CA); Chang LIU, Richmond HIll (CA)

(21) Appl. No.: 18/686,223

(22) PCT Filed: Aug. 23, 2022
(86) PCT No.: PCT/IB2022/057887

§ 371 Date: Feb. 23, 2024

Related U.S. Application Data
(60) Provisional application No. 63/236,509, filed on Aug. 24, 2021.

(51) Int. Cl. G01N 1/40; H01J 49/04

(52) U.S. Cl. CPC G01N 1/405; H01J 49/0431

(57) ABSTRACT

In various aspects, integrated specimen collection and analyte extraction devices are provided herein. For example, in accordance with various aspects of the present teachings. a device for extracting analytes from a specimen is provided, the device comprising a housing (12) defining an extraction chamber (14) for containing a known volume of a liquid specimen and having an inlet (16) for receiving the liquid specimen. A stationary phase (20) is configured to be disposed within the extraction chamber (14) in contact with the liquid sample so as to adsorb one or more analyte species thereto, wherein at least one of the stationary phase (20) and the one or more analytes adsorbed thereto within the extraction chamber (14) is removable from the extraction chamber (14) for analysis by a chemical analyzer.

### RELATED APPLICATIONS

The present application claims priority to a provisional application entitled METHODS AND SYSTEMS FOR EXTRACTING ANALYTES FROM A SAMPLE having application No. 63/236,509 filed on Aug. 24, 2021, which is incorporated by reference herein in its entirety.

### FIELD

The present teachings generally relate to the collection of a specimen to be analyzed, and more particularly, to methods and systems for collecting, extracting, and processing analytes from a liquid specimen.

### INTRODUCTION

Various sampling techniques are known for collecting specimens (e.g., biological specimens) that are to be subjected to chemical analysis. For example, venipuncture sampling is commonly utilized to collect several milliliters of blood by piercing a superficial vein of a patient. Such blood samples may be stored in bottles (e.g., vacuum tubes), refrigerated, and transported to a laboratory for further processing and analysis. Techniques for obtaining smaller volumes of a specimen are also known, for example, by obtaining blood through a finger prick. In conventional dried blood spot (DBS) testing, one or more drops of blood are applied to a filter paper to the point of saturation and the saturated paper dried such that the samples may be shipped to an analytical laboratory for further processing (e.g., elution from the DBS, sample clean-up, etc.) prior to subjecting the sample to chemical analysis such as mass spectrometry. However, variations in viscosity between and even within blood samples may bias the sampling from a DBS and make quantitation difficult, while the processing of a DBS in the laboratory may both dilute the sample and reduce the throughput of the analytical process.

There remains a need for collection techniques that can improve the ability to easily and accurately quantitate the concentration of analytes within a small-volume specimen.

### SUMMARY

Methods and systems for collecting, extracting, and processing analytes contained within a liquid specimen are described herein. In certain aspects, systems and methods described herein integrate collection of a small, fixed volume of a liquid specimen with analyte extraction therefrom, thereby improving quantitation, increasing sensitivity, and/or increasing analytical throughput. For example, in certain aspects, a known specimen volume may be collected and exposed to a stationary phase configured to selectively bind to one or more analytes within the specimen such that the stationary phase itself or the analytes extracted thereby may be removed from the collection device and analyzed without significant subsequent steps of sample processing. By exposing the stationary phase to a known specimen volume to extract the analytes of interest, a more accurate determination of the quantity or concentration of analytes in the specimen may be obtained relative to DBS testing, for example, or other conventional methods in which the sampled volume may vary by composition of the specimen or is unknown.

In accordance with various exemplary aspects of the present teachings, a device for extracting analytes from a specimen is provided, the device comprising a housing defining an extraction chamber for containing a known volume of a liquid specimen and having an inlet for receiving the liquid specimen. A stationary phase is configured to be disposed within the extraction chamber in contact with the liquid sample so as to adsorb one or more analyte species thereto, wherein at least one of the stationary phase and the one or more analytes adsorbed thereto within the extraction chamber is removable from the extraction chamber for analysis by a chemical analyzer.

In various aspects, a surface portion of the extraction chamber may comprise the stationary phase. In some alternative aspects, the stationary phase may be at least a surface portion of a substrate configured to be disposed within the extraction chamber. In various aspects, the device may be configured such that the stationary phase and/or the volume of the specimen to which it is exposed does not fully saturate selective binding sites of the stationary phase to enable quantitation of the expected range of analytes. In certain aspects, the extraction chamber may be configured to contain less than about 100 microliters of liquid sample, by way of non-limiting example.

The chemical analyzer can be any analyzer known in the art or hereafter developed for detecting the presence, absence, or concentration of analytes within a sample. By way of example, the chemical analyzer can comprise a mass spectrometer system. In certain aspects, the stationary phase and/or the one or more analytes adsorbed thereto within the extraction chamber can be delivered to a sampling probe configured to fluidly couple to an ion source of a mass spectrometer system. In certain aspects, the sampling probe can comprise an outer housing having an open end; a liquid supply conduit within the housing, the liquid supply conduit extending from an inlet end configured to be fluidly coupled to a capture liquid supply source to an outlet end configured to deliver capture liquid to a sampling space at the open end of the housing, wherein the sampling space comprises a liquid-air interface through which the at least one of the stationary phase and the one or more analytes adsorbed thereto within the extraction chamber is delivered to the capture liquid within the sample space; and a liquid exhaust conduit within the housing, the liquid exhaust conduit extending from an inlet end in fluid communication with said sampling space to an outlet end configured to fluidly couple to an ion source of the mass spectrometer system.

In some related aspects, the capture liquid may comprise a desorption solvent for desorbing said one or more analytes adsorbed to the stationary phase within the extraction chamber. In some further related aspects, the stationary phase may be at least a surface portion of a substrate configured to be disposed within the extraction chamber. In some additional related aspects, the substrate may be configured to move to a sampling configuration in which the substrate extends from the housing for insertion into the capture liquid within the sampling space while remaining coupled to the housing.

Various additional chambers may be defined within the housing of the extraction device. By way of example, in some aspects, the housing of the extraction device may further define an elution chamber for containing an elution solvent, wherein the stationary phase is configured to move from the extraction chamber to the elution chamber for desorbing said one or more analytes adsorbed to the stationary phase into the elution solvent. In some related aspects, the elution solvent containing said one or more analytes may be configured to be delivered to a sampling space of a sampling probe through a liquid-air interface at an open end of the sampling probe. For example, an acoustic droplet ejection device may be configured to eject a droplet of the elution solvent toward the open end of the sampling probe.

In some aspects, the housing of the extraction device may comprise a washing chamber for containing a washing buffer, wherein the stationary phase having one or more analytes adsorbed thereto is configured to move from the extraction chamber to the washing chamber. In some related aspects, the housing of the extraction device may further define an elution chamber for containing an elution solvent, wherein the stationary phase is configured to move from the washing chamber to the elution chamber for desorbing said one or more analytes adsorbed to the stationary phase into the elution solvent.

In some aspects, the housing of the extraction device may define a reaction chamber for containing one or more reagents for preparing the one or more analytes extracted by the stationary phase for chemical analysis.

In some aspects, the housing of the extraction device may define a conditioning chamber configured to contain a conditioning solvent, wherein the stationary phase is exposed to the conditioning solvent prior to being exposed to the liquid specimen contained within the extraction chamber.

In some aspects, the device may include a fluid flow pathway for delivering the liquid specimen to the inlet of the extraction chamber. In some related aspects, the fluid flow pathway may be configured to draw the liquid specimen into the extraction chamber via adhesion. By way of non-limiting example, the fluid flow pathway may comprise a lumen of a capillary.

In accordance with various exemplary aspects of the present teachings, a method of analyzing a specimen is provided, the method comprising filling an extraction chamber defined by a housing with a liquid specimen, wherein the extraction chamber comprises a known volume. A stationary phase may be exposed to the known volume of the liquid specimen within the extraction chamber, wherein said stationary phase is configured to adsorb one or more analytes species thereto. At least one of the stationary phase and the one or more analytes adsorbed thereto within the extraction chamber may be removed from the extraction chamber and the one or more analytes may be analyzed with a chemical analyzer.

In some aspects, the chemical analyzer can comprise a mass spectrometer system. In various related aspects, the method may further comprise delivering at least one of the stationary phase and the one or more analytes adsorbed thereto into a sampling space of a sampling probe, wherein the sampling probe comprises: an outer housing having an open end; a liquid supply conduit within the housing, the liquid supply conduit extending from an inlet end configured to be fluidly coupled to a capture liquid supply source to an outlet end configured to deliver capture liquid to a sampling space at the open end of the housing, wherein the sampling space comprises a liquid-air interface through which the at least one of the stationary phase and the one or more analytes adsorbed thereto within the extraction chamber is delivered to the capture liquid within the sample space; and a liquid exhaust conduit within the housing, the liquid exhaust conduit extending from an inlet end in fluid communication with said sampling space to an outlet end configured to fluidly couple to an ion source of the mass spectrometer system. In certain related aspects, the capture liquid may comprise a desorption solvent, wherein delivering at least one of the stationary phase and the one or more analytes adsorbed thereto into the sampling space of the sampling probe comprises inserting the stationary phase into the desorption solvent to desorb said one or more analytes therefrom.

In certain aspects, the one or more analytes may be desorbed from the stationary phase prior to being delivered to the capture liquid within the sampling space of the sampling probe. For example, in certain aspects, the method may further comprise utilizing an acoustic droplet ejection device to eject a droplet containing the desorbed one or more analytes toward the open end of the sampling probe.

In various aspects, the fluid specimen is received through an inlet of the extraction chamber through a fluid flow pathway configured to draw the liquid into the extraction chamber via adhesion.

In various aspects, the extraction chamber may exhibit a volume less than about 100 microliters.

In various aspects, the method may further comprise exposing the stationary phase having analytes adsorbed thereto to a washing buffer contained within the housing.

In various aspects, the method may further comprise exposing the one or more analytes extracted by the stationary phase to one or more reagents contained within the housing to prepare the one or more analytes for chemical analysis.

In various aspects, the method may further comprise exposing the stationary phase to a conditioning solvent contained within the housing prior to being exposed to the liquid specimen contained within the extraction chamber.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1, in a schematic diagram, illustrates an exemplary sample collection unit in accordance with various aspects of the applicant's teachings.

FIGS. 2A-B schematically depict an exemplary sample collection unit having a stationary phase configured for insertion within an open-port sampling probe in accordance with various aspects of the present teachings.

FIGS. 3A-B schematically depict another exemplary sample collection unit having a stationary phase configured for insertion within an open-port sampling probe in accordance with various aspects of the present teachings.

FIG. 4, in a schematic diagram, illustrates another exemplary sample collection unit in accordance with various aspects of the applicant's teachings.

FIG. 5, in a schematic diagram, illustrates another exemplary sample collection unit in accordance with various aspects of the applicant's teachings.

FIG. 6, in a schematic diagram, illustrates another exemplary sample collection unit in accordance with various aspects of the applicant's teachings.

FIGS. 7A-C, in a schematic diagram, illustrates the use of another exemplary sample collection unit in accordance with various aspects of the applicant's teachings

FIGS. 8A-D, in a schematic diagram, illustrates the use of another exemplary sample collection unit in accordance with various aspects of the applicant's teachings

FIG. 9, in a schematic diagram, illustrates another exemplary sample collection unit in accordance with various aspects of the applicant's teachings.

FIG. 10, in a schematic diagram, illustrates another exemplary sample collection unit in accordance with various aspects of the applicant's teachings.

FIG. 11, in a schematic diagram, illustrates another exemplary sample collection unit in accordance with various aspects of the applicant's teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

In accordance with various aspects of the applicant's teachings, methods and systems described herein enable the collection and extraction of analytes of interest from a small volume of a liquid specimen. Whereas conventional sampling techniques such as DBS may only require a small amount of a specimen, such methods nonetheless typically require collected samples to undergo extensive sample clean-up prior to analysis, which may make detection unreliable due to dilution and/or contamination during sample prep. Moreover, though DBS may enable determination of the presence (or absence) of an analyte in a specimen, such a technique cannot reliably indicate the concentration of the analyte in the specimen, for example, because the volume from which the analytes are derived is unknown or varies due to differences in the characteristics of the specimen. By way of example, variations in the hydration and the viscosity of a blood sample due to differences in hematocrit may cause a drop of blood to spread differently on a DBS card such that the dried area that. is selected for analysis may not accurately represent the concentration of analytes within the liquid specimen.

However, in accordance with various aspects of the present teachings, systems and methods described herein provide for the collection of a known specimen volume within an extraction chamber of a sample collection unit within which a stationary phase may be disposed such that the stationary phase may bind to analytes of interest within the extraction chamber. It will be appreciated in light of the present teachings that by exposing the stationary phase to a known specimen volume from which the analytes of interest are extracted, a more accurate determination of the concentration of analytes within the specimen may be obtained. In addition, the integration of collection and extraction within the extraction chamber can be effective to reduce sample processing steps prior to chemical analysis. For example, as discussed in detail below in some example embodiments, the stationary phase may be washed within the sample collection unit to remove specimen matrix or other interfering analytes prior to providing the stationary phase or the analytes extracted thereby to a chemical analyzer, for example. Indeed, in various aspects, washing, eluting, and/or reacting the extracted analytes within sample collection units described herein may be effective to eliminate conventional post-collection sample processing steps, which may increase analytical throughput and reduce sources of error such as caused by dilution and/or contamination.

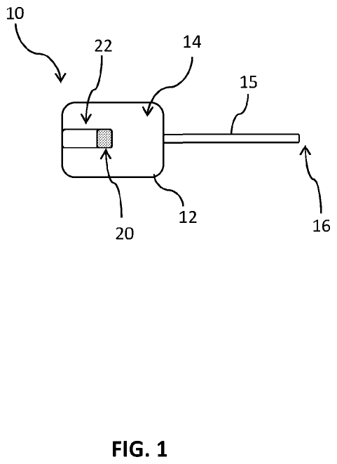

With reference now to FIG. 1, an exemplary sample collection unit 10 in accordance with various aspects of the applicant's teachings is depicted in which a selective-binding stationary phase 20 is disposed within an extraction chamber 14. As shown, the sample collection unit 10 generally comprises a housing 12 defining the extraction chamber 14 for containing a known volume of liquid specimen, which may be received through an inlet 16 in fluid communication with the extraction chamber 14. The extraction chamber 14 can define a variety of volumes. In some example aspects, the volume of the extraction chamber 14 may be in the microliter regime, for example, in a range from about 0.1 microliters to about 100 microliters. In some aspects, the volume of the extraction chamber may be less than about 100 microliters (e.g., about 10 microliters)

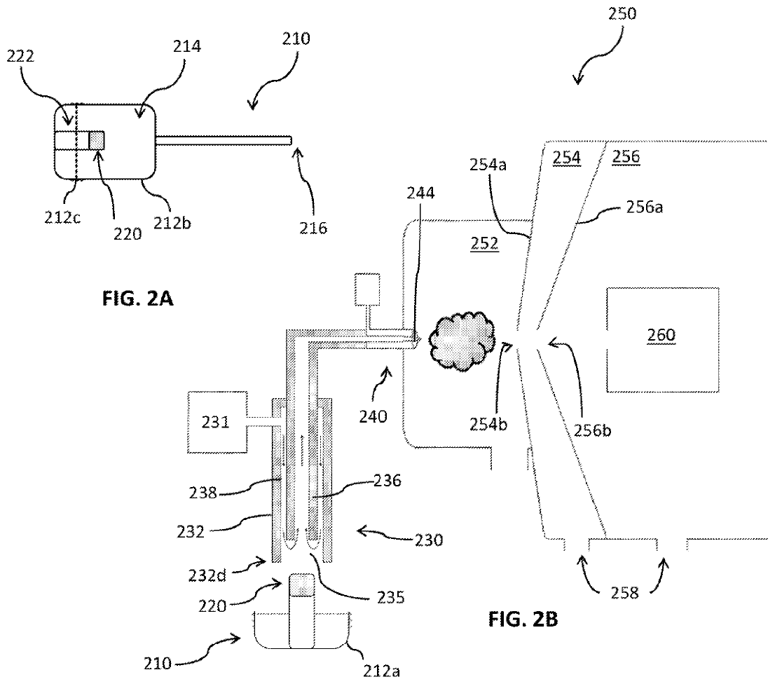

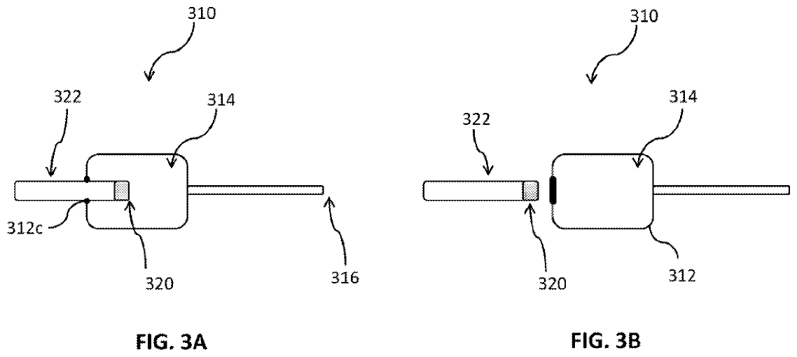

As shown in FIG. 1, the stationary phase 20 comprises a coating on a surface portion of an elongate substrate 22 extending from the housing 12 and disposed within the extraction chamber 14. The substrate 22 can comprise a variety of shapes and materials in accordance with the present teachings, though in some aspects, may be configured to enable direct sampling by a sampling interface of a mass spectrometer system. For example, as discussed below with reference to FIGS. 2 and 3, in certain aspects, the housing 12 and/or the substrate 22 may be configured to expose the surface portion 20 (e.g., after binding to one or more analytes within the extraction chamber 14) to enable direct sampling by a chemical analyzer and/or to allow one or more sample processing steps to prepare the analytes bound to the stationary phase 20 for further analysis.

The stationary phase 20 can have a variety of configurations, but in certain aspects may be a surface coating that is configured to bind to one or more analytes contained within the specimen. It will be appreciated that the surface coating is not particularly limited and may be appropriately selected by those skilled in the art depending, for example, on the identity of the specimen (e.g., blood, urine, water sample), the target analyte(s), and/or potentially interfering analytes. For example, the stationary phase 20 may be a portion of the substrate 22 functionalized with a solid phase extraction medium such as HLB-PAN, C18-PAN, antibodies, etc., all by way of non-limiting example. Indeed, any stationary phase, coating, or surface treatment known in the art or hereafter developed, modified in accordance with the present teachings may be utilized in accordance with the present teachings to extract analytes from a liquid specimen within the extraction chamber 14. Example functionalized surfaces suitable for use as the stationary phase 20 are described in PCT Pub. No. WO2020079467, entitled “Functionalizing a Sampling Element for Use with a Mass Spectrometry System,” the teachings of which are incorporated by reference in its entirety.

In various aspects, the device may be configured such that the stationary phase 20 and/or the volume of the liquid specimen (i.e., the volume of the extraction chamber 14) is not likely to occupy all of the selective binding sites of the stationary phase 20 when exposed to the liquid specimen. By way of example, if the analyte concentration is sufficiently high or if the available binding sites of the stationary phase 20 is too low (e.g., too small of a coated area), the stationary phase 20 may become saturated such that higher concentrations cannot be quantified. Thus, in certain aspects, the relative volume of the extraction chamber 14 and/or the surface area of the stationary phase 20 disposed therein may be optimized in accordance with the present teachings so as to enable quantitation of the expected range of concentration of the analytes.

The inlet 16 through which a liquid specimen is received within the extraction chamber 14 can have a variety of configurations. By way of non-limiting example, the inlet may comprise a port or other opening through which a liquid specimen may be injected to fill the extraction chamber 14. However, in the depicted example collection unit of FIG. 1, the inlet 16 comprises an opening of a fluid flow pathway between the external environment and the extraction chamber 14. In some example aspects, the fluid flow pathway may be configured to aspirate liquid into the extraction chamber 14. As shown in FIG. 1, liquid may be drawn from the inlet 16 and into the extraction chamber 14 as a result of adhesion (e.g., via capillary action between the liquid specimen in contact with the inlet 16 and the inner lumen of the capillary 15).

With reference now to FIGS. 2A and 2B, another example sample collection unit 210 suitable for use with a chemical analyzer system 250 is depicted. The sample collection unit 210 is similar to that depicted in FIG. 1, but differs in that the housing is separable in that it comprises a first housing portion 212a and a second housing portion 212b that may be removably coupled to one another. The first and second housing portions 212a,b can be removably coupled in any manner known in the art (e.g., clamps, adhesive, compression fit, etc.), but in FIG. 2A are shown as being coupled via corresponding threads and bores 212c such that one housing portion may be screwed into the other. In this manner, upon collecting the specimen within the extraction chamber 214 and extracting the analytes therefrom, the first and second housing portions 212a,b may be de-coupled such that the substrate 222 extends from the first portion 212a and is available for further processing and/or sampling from the stationary phase 220 as shown in FIG. 2B. In accordance with various aspects of the present teachings, the stationary phase 220 may be sampled directly by the sampling probe 230 of chemical analyzer system 250, or alternatively, may be subject to further processing such as washing of the stationary phase 220.

The chemical analyzer system 250 can be any analyzer known in the art or hereafter developed for detecting the presence, absence, or concentration of analytes within a sample. In the depicted example, the chemical analyzer system 250 comprises a mass spectrometer system for ionizing and mass analyzing analytes from a stationary phase 220 received through a liquid/air interface of a sampling probe 230. As shown, the system 250 generally includes a sampling probe 230 (e.g., an open-port interface (OPI)) in fluid communication with an ion source 240 for discharging a liquid containing one or more sample analytes into an ionization chamber 252 (e.g., via electrospray electrode 244), and a mass analyzer 260 in fluid communication with the ionization chamber 252 for downstream processing and/or detection of ions generated by the ion source 240.

An example of an open port sampling probe 230 suitable for use in accordance with the present teachings is described, for example, in an article entitled “An open port sampling interface for liquid introduction atmospheric pressure ionization mass spectrometry” of Van Berkel et al., published in Rapid Communications in Mass Spectrometry, 29(19), pp. 1749-1756 (2015), which is incorporated by reference in its entirety. As shown in FIG. 2B, the sampling probe 230 generally comprises an outer housing 232 (e.g., capillary tube) having an end 232d that is open to the atmosphere and through which the stationary phase 220 having one or more analytes adsorbed thereto can be received. A liquid supply conduit 238 within the outer housing 232 extends from an inlet end configured to be coupled to a capture liquid supply source 231 to an outlet end configured to deliver capture liquid from the liquid supply source 231 to the open end 232d. The example housing 232 also includes a liquid exhaust conduit 236 (e.g., an inner capillary tube) that extends from a sampling space 235 having a liquid/air interface adjacent the open end 232d to an outlet end such that capture liquid containing the analytes can be transported from the sampling space 235 to the ion source 240 via the liquid exhaust conduit 236. Though the example sampling probe 230 of FIG. 2B includes an inner, liquid exhaust conduit 236 disposed co-axially within the liquid supply conduit 238, it will be appreciated in light of the present teachings that the arrangement of the liquid supply conduit 238 and the liquid exhaust conduit 236 can be varied. For example, though the liquid exhaust conduit 236 is depicted as being surrounded by the liquid supply conduit 238, the liquid exhaust conduit 236 can in some aspects instead be disposed around the liquid supply conduit 238. In addition, in various aspects, the supply and exhaust conduits 238, 236 can have a variety of other relative orientations (e.g., side-by-side, end-to-end), but are generally configured that the outlet end of the supply conduit 238 and the inlet end of the exhaust conduit 236 deliver liquid to and remove liquid from, respectively, a sampling space at the open end 232d of the sampling probe 320. In accordance with various aspects of the present teachings, the stationary phase 220 may be configured to be fully inserted into the sampling space 235 of the sampling probe 230 so as to allow for capture (e.g., elution) of the analytes extracted from the liquid specimen by the stationary phase 220 within the capture liquid. By way of example, in some particular aspects, the stationary phase 220 may be sized and shaped so as to be able to be inserted through the liquid/air interface and be fully received within the sampling space 235 as shown in FIG. 2B.

It will be appreciated that sampling probes in accordance with the present teachings can have a variety of configuration and sizes, with the sampling probe 230 of FIG. 2B representing an exemplary depiction. By way of non-limiting example, the dimensions of an inner diameter of the inner exhaust conduit 236 can be in a range from about 1 micron to about 1 mm (e.g., 200 microns), with exemplary dimensions of the outer diameter of the inner conduit 236 being in a range from about 100 microns to about 3 or 4 centimeters (e.g., 360 microns). Also by way of example, the dimensions of the inner diameter of the outer conduit 238 can be in a range from about 100 microns to about 3 or 4 centimeters (e.g., 950 microns), with the typical dimensions of the outer diameter of the outer conduit 238 being in a range from about 150 microns to about 3 or 4 centimeters (e.g., about 2 millimeters to about 5 millimeters). The cross-sectional shapes of the inner and/or the outer conduits 238, 236 can be circular, elliptical, superelliptical (i.e., shaped like a superellipse), or even polygonal (e.g., square). In one example embodiment, the inner conduit 236 may exhibit a circular cross-sectional shape exhibiting an inner diameter of about 250 microns and an outer diameter of about 800 microns, while the outer conduit 236 has a circular cross-sectional shape exhibiting an inner diameter of about 950 microns such that a fluid pathway is defined by the annular space between the inner wall of the outer 236 and the outer wall of the inner conduit 238.

The capture liquid provided to the sampling space 235 via the liquid supply conduit 238 can be any suitable liquid amenable to the ionization process, including water, methanol, and acetonitrile, and mixtures thereof, all by way of non-limiting examples. For example, in certain aspects, the capture liquid may be a desorption solvent configured to desorb any extracted analytes from the stationary phase 220. The capture liquid supply source 231 can be any suitable source (e.g., a container, reservoir, etc.) and a pumping mechanism (not shown) can be provided to pump the liquid from the source 231 to the open end 232d via the liquid supply conduit 238 at a selected volumetric flow rate. Example pumping mechanisms include HPLC pumps, reciprocating pumps, positive displacement pumps such as rotary, gear, plunger, piston, peristaltic, diaphragm pump, and other pumps such as gravity, impulse and centrifugal pumps, all by way of non-limiting example.

The ion source 240 can have a variety of configurations but is generally configured to generate ions from analyte(s) contained within the capture liquid received via the liquid exhaust conduit 236, which may be directly or indirectly fluidly coupled to the ion source 240 via one or more fluid coupling mechanisms (e.g., couplers, conduits, tubes, valves). In the exemplary embodiment depicted in FIG. 2B, an electrospray electrode 244, which can comprise a capillary fluidly coupled to the liquid exhaust conduit 234 extending from the sampling space 235, terminates in an outlet end that at least partially extends into the ionization chamber 252 and discharges the capture liquid therein. As will be appreciated by a person skilled in the art, the outlet end of the electrospray electrode 244 can atomize, aerosolize, nebulize, or otherwise discharge (e.g., spray with a nozzle) the capture liquid into the ionization chamber 252 to form a sample plume comprising a plurality of micro-droplets generally directed toward (e.g., in the vicinity of) the curtain plate aperture 254b and vacuum chamber sampling orifice 256b. As is known in the art, analytes contained within the micro-droplets can be ionized (i.e., charged) by the ion source 240, for example, as the sample plume is generated. By way of non-limiting example, the outlet end of the electrospray electrode 244 can be made of a conductive material and electrically coupled to a pole of a voltage source (not shown), while the other pole of the voltage source can be grounded. Micro-droplets contained within the sample plume can thus be charged by the voltage applied to the outlet end such that as the liquid within the droplets evaporates during desolvation in the ionization chamber 252 bare charged analyte ions are released and drawn toward and through the apertures 254b, 256b and focused (e.g., via one or more ion lens) into the mass analyzer 260. Though the ion source probe is generally described herein as an electrospray electrode 244, it should be appreciated that any number of different ionization techniques known in the art for ionizing liquid samples and modified in accordance with the present teachings can be utilized as the ion source 240. By way of non-limiting example, the ion source 240 can be an electrospray ionization device, a nebulizer assisted electrospray device, a chemical ionization device, a nebulizer assisted atomization device, a photoionization device, a laser ionization device, a thermospray ionization device, or a sonic spray ionization device.

The ionization chamber 252 can be maintained at about atmospheric pressure, though in some embodiments, the ionization chamber 252 can be evacuated to a pressure lower than atmospheric pressure. The ionization chamber 252, within which analytes within the sample mixture that is discharged from the electrospray electrode 244 can be ionized, is separated from a gas curtain chamber 254 by a plate 254a having a curtain plate aperture 254b. As shown, a vacuum chamber 256, which houses the mass analyzer 260, is separated from the curtain chamber 254 by a plate 256a having a vacuum chamber sampling orifice 256b. The curtain chamber 254 and vacuum chamber 256 can be maintained at a selected pressure(s) (e.g., the same or different sub-atmospheric pressures, a pressure lower than the ionization chamber) by evacuation through one or more vacuum pump ports 258.

It will also be appreciated by a person skilled in the art and in light of the teachings herein that the mass analyzer 260 can have a variety of configurations. Generally, the mass analyzer 260 is configured to process (e.g., filter, sort, dissociate, detect, etc.) sample ions generated by the ion source 240. By way of non-limiting example, the mass analyzer 260 can be a triple quadrupole mass spectrometer, or any other mass analyzer known in the art and modified in accordance with the teachings herein. It will further be appreciated that any number of additional elements can be included in the mass spectrometer system including, for example, an ion mobility spectrometer (e.g., a differential mobility spectrometer) that is configured to separate ions, for example, based on their mobility differences at high-and low-field strength through a drift gas rather than the ions' mass-to-charge ratio. Additionally, it will be appreciated that the mass analyzer 260 can comprise a detector that can detect the ions which pass through the analyzer 260 and can, for example, supply a signal indicative of the number of ions per second that are detected.

With reference now to FIGS. 3A and 3B, another example sample collection unit 310 suitable for use with an open port sampling probe is depicted. The sample collection unit 310 is similar to that of FIGS. 2A and 2B, but differs in that the substrate 322 is removable from the housing 312. By way of non-limiting example, the substrate 322 extends through a bore within the housing 312 such that the stationary phase 320 is disposed within the extraction chamber until analytes have been extracted therefrom as shown in FIG. 3A. An O-ring 312c, for example, may be configured to seal the extraction chamber 314 about the substrate 322 such that the liquid specimen contained within the extraction chamber 314 can be prevented from leaking. Thereafter, as shown in FIG. 3B, the substrate 330 can be pulled from the housing 212. With the stationary phase 320 having analytes adsorbed thereto, the stationary phase 220 may be processed for chemical analysis (e.g., cleaning, isolating, concentrating, derivatizing the one or more adsorbed analytes) and/or may be sampled by the chemical analyzer (e.g., by an open port sampling interface 230 of system 250) for analysis thereby.

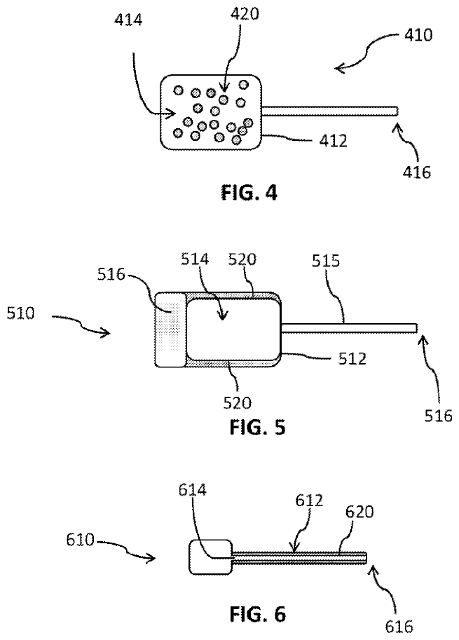

Though stationary phases described above with reference to FIGS. 1-3 are formed as a surface portion of an elongated substrate configured to be disposed within the extractions chambers, the present teachings are not so limited. By way of example, as shown in FIG. 4, another example specimen collection unit 410 in accordance with the present teachings provide a plurality of spherical elements having an outer surface coated with a stationary phase 420. Such surface-coated elements 420 may be configured to be suspended within the liquid specimen contained within extraction chamber 414 as the liquid specimen is received. In various aspects, the coated elements 420 may be configured to be mixed within the liquid specimen, thereby increasing the interaction of the stationary phase 420 with the analytes. By way of example, the housing 412 may be placed in contact with a shaker for perturbing the liquid specimen and the elements 420. In certain aspects, the elements 420 may be magnetized such that the housing 412 may be disposed within an electromagnetic assembly capable of generating magnetic field gradients that may cause movement by the magnetic elements. Examples of such assemblies suitable for use with the present teachings are described, for example, in PCT Pub. No. WO2018138631 entitled “Electromagnetic Assemblies for Processing Fluids,” the teachings of which are incorporated by reference in its entirety. Additionally, in various aspects, the present teachings provide that the stationary phase having extracted analytes adsorbed thereto may be removed from the extraction chamber for further processing (e.g., sample clean-up) and/or chemical analysis.

With reference now to FIG. 5, another example specimen collection unit 510 in accordance with the present teachings is depicted. Unlike the collection units described above in which the stationary phases are removable from the housing for sampling by a chemical analyzer, for example, the stationary phase 520 of specimen collection unit 510 is formed on at least a surface portion of the housing 512. In accordance with various aspects of the present teachings, the analytes captured by the stationary phase 520 may be washed, eluted, and/or further processed within the extraction chamber 514 to be removed from the extraction chamber 514 for chemical analysis. By way of example, the capillary 515 and end of the housing 512 may be removable as otherwise discussed herein, the liquid specimen removed, and one or more washing buffers, desorption solvents, and/or reagents added to the extraction chamber 514 to prepare the analytes that were extracted by the stationary phase 520 for chemical analysis. In some example aspects, at least a portion of the housing 512 may comprise an acoustic coupling medium 516 such when coupled to a source of acoustic radiation, acoustic energy may cause droplets of liquid containing the desorbed analytes to be ejected from a surface of the liquid within the extraction chamber 514. Such sample droplets may be configured to be received by a chemical analyzer for analysis thereby. For example, as discussed above with reference to FIG. 2B, such droplets ejected from the sample liquid may be received within an open port of a sampling interface of a mass spectrometer system. Examples of such acoustic ejection assemblies suitable for use with the present teachings are described, for example, in U.S. Pat. No. 10,770,277 entitled “System and Method for the Acoustic Loading of an Analytical Instrument Using a Continuous Flow Sampling Probe,” the teachings of which are incorporated by reference in its entirety.

With reference now to FIG. 6, another example specimen collection unit 610 in accordance with the present teachings is depicted. As shown in FIG. 6, the sample collection unit 610 comprises a housing 612 defining an internal lumen 614 extending therethrough. The internal surface of the lumen 614 may be coated with a stationary phase 620 as otherwise discussed herein such that analytes may be extracted from the liquid specimen as it is drawn through the lumen 614, for example, via capillary action. In certain aspects, the housing 612 may be removed and the lumen 614 flushed to prepare the analytes for chemical analysis. In some example aspects, the lumen 614 may be fluidically coupled to a desorption solvent source and an ion source of a mass spectrometer, for example, such that the analytes adsorbed to the stationary phase 620 may be delivered to the ion source as they are eluted from the stationary phase.

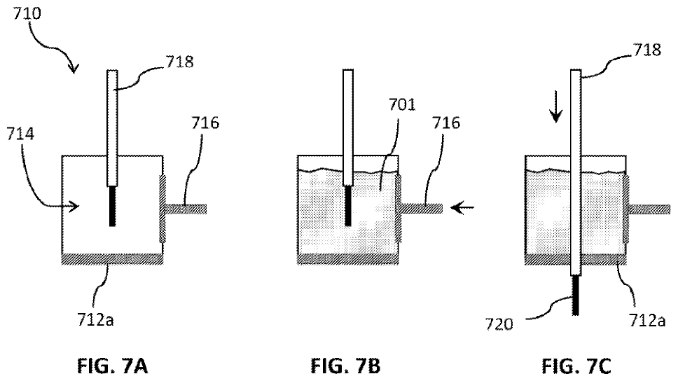

With reference now to FIGS. 7A-C, another example specimen collection unit 710 in accordance with the present teachings is depicted. The unit 710 comprises a housing 712 defining an extraction chamber 714 for containing a known volume of liquid specimen 701 received through the inlet 716 as shown in FIG. 7B. Upon one or more analytes of interest within the specimen 701 binding to the stationary phase 720, the stationary phase 720 may be removed from the extraction chamber 714 for chemical analysis. As shown in FIG. 4C, for example, a portion 712a of the housing 712 may comprise a membrane (e.g., plenum) that may be pierced by the stationary phase 720 upon manual or electromechanical actuation of an actuator 718 (e.g., a pushrod) such that the stationary phase 720 is exposed external to the housing 812 for further processing.

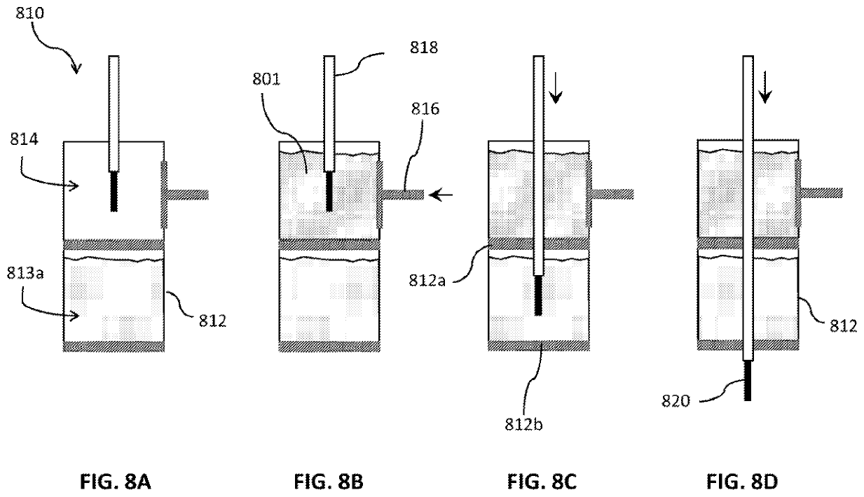

With reference now to FIGS. 8A-C, another example specimen collection unit 810 in accordance with various aspects of the present teachings is depicted. The specimen collection unit 810 is similar to that of FIGS. 7A-B but differs in that that the housing 812 additionally comprises a washing chamber 813a that is separated from the extraction chamber 814 by a first membrane 812a. The washing chamber 813a contains a washing buffer, for example, for removing residual liquid specimen from the stationary phase 820. The washing buffer may be added by a user, for example, or may be pre-loaded. Upon analytes of interest within the specimen 801 binding to the stationary phase 820 as in the configuration of FIG. 8B, the stationary phase 820 may be transferred from the extraction chamber 814 for chemical analysis through membrane 812a (e.g., via actuation of actuator 818) as shown in FIG. 8C. The stationary phase 820 may be exposed to the washing buffer for a duration sufficient to clean residual liquid specimen and/or interfering analytes therefrom, for example, and then exposed for further processing by being transferred from the washing chamber 813a through membrane 812b.

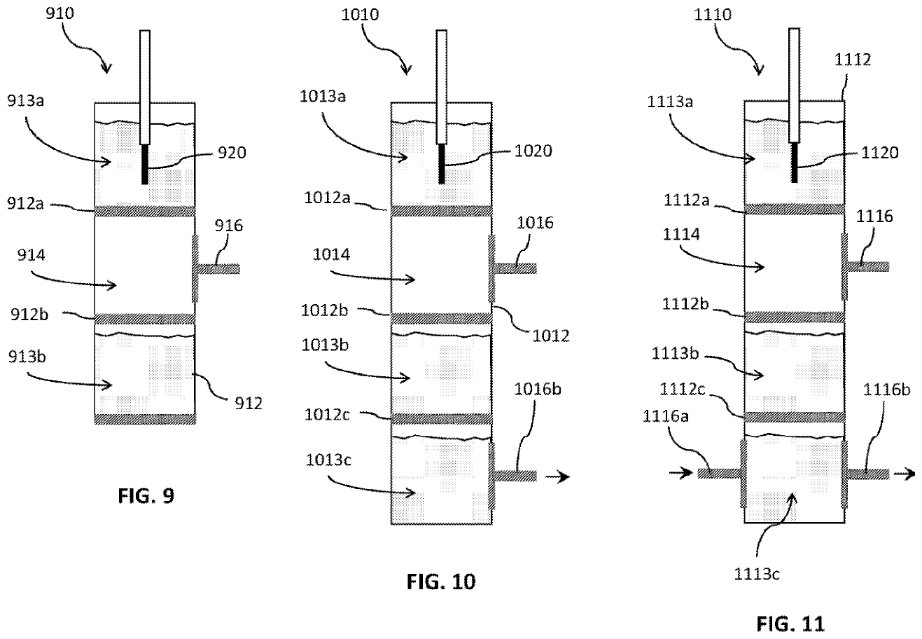

In addition or alternatively to a washing chamber discussed above, one or more other sample processing steps can be integrated within specimen collection and extraction units in accordance with the present teachings. For example, with reference now to FIG. 9, the device 910 includes a pre-conditioning chamber 913a within which the stationary phase 920 may be stored or immersed prior to being exposed to the specimen within the extraction chamber 814. For example, the pre-conditioning chamber 913a may include a pre-conditioning solution to help provide whetting of the stationary phase 920 to provide better contact between the liquid specimen and the stationary phase 920 upon being transferred to the extraction chamber 914. By way of example, when the stationary phase 920 is hydrophobic, the pre-conditioning solution may prevent the formation of small bubbles on the surface of the stationary phase 920, which may reduce extraction efficiency. Examples of suitable pre-conditioning solutions that may be pre-loaded or loaded by the user include a mixture of water and an organic liquid such as a 50:50 solution of water and methanol, by way of non-limiting example. After conditioning, the stationary phase 920 may then be transferred through membrane 912a to the extraction chamber 914 containing or configured to contain the liquid specimen received through inlet 916. Following adsorption of the one or more analytes within the specimen, the stationary phase 920 may then be transferred through membrane 912b to a washing chamber 913b as discussed above with reference to FIG. 8.

FIG. 10 depicts another example integrated collection and extraction unit 1010 in accordance with various aspects of the present teachings. Like the unit 910 of FIG. 9, the unit 1010 comprises a pre-conditioning chamber 1013a, an extraction chamber 1014, and a washing chamber 1013b, which are separated by pierceable membranes 1012a and 1012b. Additionally, the unit 1010 includes an elution chamber 1013c into which the stationary phase 1020 may be transferred (e.g., via membrane 1012c). The elution chamber 1013c may contain an elution solvent, for example, that is configured to desorb analytes bound to the stationary phase 1020. An outlet 1016b, for example, can allow for the transfer (e.g., via a fluid flow pathway, via aspiration) of the desorbed analytes contained within the elution solvent for further chemical analysis. It will be appreciated that a membrane like that of 1012a and 1012b can instead be provided (e.g., on the bottom of the unit 1010 as shown in FIG. 10) to allow, for example, a device (e.g., a needle, pipette) to pierce the membrane to remove the contents within the elution chamber 1013c.

FIG. 11 depicts another example integrated collection and extraction unit 1110 in accordance with various aspects of the present teachings. Like the unit 910 of FIG. 9, the unit 1110 comprises a pre-conditioning chamber 1113a, an extraction chamber 1114, and a washing chamber 1113b, which are separated by pierceable membranes 1112a and 1112b. Additionally, the example unit 1110 includes a reaction chamber 1113c within which the analytes extracted by the stationary phase 1120 may be reacted with one or more reagents. As shown, in some example aspects, the reaction chamber 1113 may include an outlet 1116b for removing the reaction products (e.g., via a fluid flow pathway, via aspiration). Additionally, the reaction chamber 1113c includes an inlet 1116c through which one or more reagents may be added by a user (e.g., injected, pumped) in order to perform the desired reactions within the integrated unit 1110. It will be appreciated that a membrane like that of 1012a and 1012b can instead be provided (e.g., on the bottom of the unit 1110 as shown in FIG. 11) to allow, for example, a device (e.g., a needle, pipette) to pierce the membrane to add or remove materials to or from the reaction chamber 1113c.

Although some aspects above have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

What is claimed is:

1. A device for extracting analytes from a specimen, comprising:
a housing defining an extraction chamber for containing a known volume of a liquid specimen, said extraction chamber comprising an inlet for receiving the liquid specimen; and
a stationary phase configured to be disposed within the extraction chamber in contact with the liquid specimen, said stationary phase configured to adsorb one or more analyte species thereto,
wherein at least one of the stationary phase and the one or more analytes adsorbed thereto within the extraction chamber is removable from the extraction chamber for analysis by a chemical analyzer.

2. The device of claim 1, wherein a surface portion of the extraction chamber comprises the stationary phase.

3. The device of claim 1, wherein the stationary phase is at least a surface portion of a substrate configured to be disposed within the extraction chamber.

4. The device of claim 1, wherein the chemical analyzer comprises a mass spectrometer system.

5. The device of claim 1, wherein a sampling probe is configured to fluidly couple to an ion source of a mass spectrometer system, wherein the sampling probe comprises:
an outer housing having an open end;
a liquid supply conduit within the outer housing, the liquid supply conduit extending from an inlet end configured to be fluidly coupled to a capture liquid supply source to an outlet end configured to deliver the capture liquid to a sampling space at the open end of the outer housing, wherein the sampling space comprises a liquid-air interface through which the at least one of the stationary phase and the one or more analytes adsorbed thereto within the extraction chamber is delivered to the capture liquid within the sampling space; and
a liquid exhaust conduit within the outer housing, the liquid exhaust conduit extending from an inlet end in fluid communication with said sampling space to an outlet end configured to fluidly couple to an ion source of the mass spectrometer system.

6. The device of claim 5, wherein the capture liquid comprises a desorption solvent for desorbing said one or more analytes adsorbed to the stationary phase within the extraction chamber.

7. The device of claim 6, wherein the stationary phase is at least a surface portion of a substrate configured to be disposed within the extraction chamber.

8. The device of claim 7, wherein the substrate is configured to move to a sampling configuration in which the substrate extends from the housing for insertion into the capture liquid within the sampling space while remaining coupled to the housing.

9. The device of claim 1, wherein the housing further defines an elution chamber for containing an elution solvent, wherein the stationary phase is configured to move from the extraction chamber to the elution chamber for desorbing said one or more analytes adsorbed to the stationary phase into the elution solvent.

10. The device of claim 9, wherein the elution solvent containing said one or more analytes is configured to be delivered to a sampling space of a sampling probe through a liquid-air interface at an open end of the sampling probe.

11. The device of claim 10, wherein an acoustic droplet ejection device is configured to eject a droplet of the elution solvent toward the open end of the sampling probe.

12. The device of claim 1, wherein the housing further defines a washing chamber for containing a washing buffer, wherein the stationary phase having one or more analytes adsorbed thereto is configured to move from the extraction chamber to the washing chamber.

13. The device of claim 12, wherein the housing further defines an elution chamber for containing an elution solvent, wherein the stationary phase is configured to move from the washing chamber to the elution chamber for desorbing said one or more analytes adsorbed to the stationary phase into the elution solvent.

14. The device of claim 1, wherein the housing further defines a reaction chamber for containing one or more reagents for preparing the one or more analytes extracted by the stationary phase for chemical analysis.

15. The device of claim 1, wherein the housing further defines a conditioning chamber configured to contain a conditioning solvent, wherein the stationary phase is exposed to the conditioning solvent prior to being exposed to the liquid specimen contained within the extraction chamber.

16. The device of claim 1, wherein the extraction chamber is configured to contain less than about 100 microliters of liquid specimen.

17. The device of claim 1, further comprising a fluid flow pathway for delivering the liquid specimen to the inlet of the extraction chamber.

18. The device of claim 17, wherein the fluid flow pathway is configured to draw the liquid specimen into the extraction chamber via adhesion.

19. The device of claim 18, wherein the fluid flow pathway comprises a lumen of a capillary.

20-30. (canceled)
